(19) United States
(12) Patent Application Publication
(10) Pub. No.: US 2018/0219793 A1
(43) Pub. Date: Aug. 2, 2018

(54) NETWORK FUNCTIONS VIRTUALIZATION RESOURCE PROCESSING METHOD AND VIRTUALIZED NETWORK FUNCTION MANAGER

(71) Applicant: HUAWEI TECHNOLOGIES CO., LTD., Shenzhen (CN)

(72) Inventors: Li JI, Shanghai (CN); Ruiyue Xu, Shanghai (CN)

(73) Assignee: HUAWEI TECHNOLOGIES CO., LTD., Shenzhen (CN)

(21) Appl. No.: 15/940,102

(22) Filed: Mar. 29, 2018

Related U.S. Application Data
(63) Continuation of application No. PCT/CN2015/091066, filed on Sep. 29, 2015.

(51) Int. Cl. H04L 12/911; H04L 29/08

(52) U.S. Cl. CPC H04L 47/70; H04L 67/146; H04L 67/141

(57) ABSTRACT

In a NFV resource processing method and a VNFM, a first VNFM sends, without using an NFVO, a first resource request message for requesting a resource to a second VNFM connected to the first VNFM. When a resource of a target VIM connected to the second VNFM meets information about a resource that is applied for, the first VNFM determines, according to a received first feedback message, information about the target VIM that can reserve or allocate the resource that is applied for. A resource management network is formed between the first VNFM and the second VNFM, so that the interconnected VNFMs can perform resource processing. This process does not require participation of the NFVO. Therefore, impact on the network if the NFVO is faulty is avoided, and a distributed resource management manner is implemented.

### CROSS-REFERENCE TO RELATED APPLICATIONS

This application is a continuation of International Patent Application No. PCT/CN2015/091066 filed on Sep. 29, 2015. The disclosure of the aforementioned application is hereby incorporated by reference in the entity.

### TECHNICAL FIELD

The present disclosure relates to the network functions virtualization field, and in particular, to a network functions virtualization resource processing method and a virtualized network function manager.

### BACKGROUND

With the development of cloud technologies, as a basic technology of cloud computing, virtualization technology has been widely used in enterprise data centers and the large-scale cluster computing field. According to network functions virtualization (NFV) technology, many types of network devices can be combined in an industry standard by using virtualization technology of an information technology (Information Technology, IT). For example, services, switching, and storage may be deployed in a data center or a network node. Various network functions are implemented in software. The various network functions can run on an industry standard server, and can further be migrated, instantiated, redeployed, or the like as required, to generate a virtualized network function (VNF) without a need for installation of a new device. A network service (NS) may be implemented between multiple virtualized network functions. In an NFV network architecture, one NFV orchestrator (NFVO) may manage multiple virtualized network function managers VNFM), one VNFM may manage multiple VNFs, and the NFVO controls management and allocation of multiple virtualized infrastructure manager (VIM) resources.

However, both resource allocation and resource management need to be performed by using the NFVO in the prior art, and relatively serious network impact may be caused when the NFVO encounters a single point of failure.

### SUMMARY

Embodiments of the present invention provide a network functions virtualization resource processing method and a virtualized network function manager, to improve robustness and efficiency of a network during resource allocation management.

A first aspect of the embodiments of the present invention provides a network functions virtualization resource processing method, including:

sending, by a first virtualized network function manager VNFM, a first resource request message to a second VNFM, where the first resource request message includes information about a resource for which the first VNFM applies for a virtualized network function VNF; and

when a resource of a target virtualized infrastructure manager VIM connected to the second VNFM meets the information about the resource that is applied for, receiving, by the first VNFM, a first feedback message sent by the second VNFM, where the first feedback message includes information about the target VIM that has reserved a resource for or allocated a resource to the first VNFM.

With reference to the first aspect of the embodiments of the present invention, in a first implementation of the first aspect of the embodiments of the present invention,

when the first feedback message includes the information about the target VIM that has reserved a resource for the first VNFM, after the receiving, by the first VNFM, a first feedback message sent by the second VNFM, the method further includes:

sending, by the first VNFM, a first resource allocation message to the target VIM, where the first resource allocation message is used by the target VIM to allocate the resource that is applied for.

With reference to the first implementation of the first aspect of the embodiments of the present invention, in a second implementation of the first aspect of the embodiments of the present invention,

the first feedback message includes a resource reservation identifier, the first resource allocation message includes the resource reservation identifier, and the resource reservation identifier is used to identify the reserved resource.

With reference to the first aspect of the embodiments of the present invention, in a third implementation of the first aspect of the embodiments of the present invention,

when the first feedback message includes the information about the target VIM that has allocated a resource to the first VNFM, the first feedback message further includes any combination of the following information: an identifier of a target virtual machine VM allocated by the target VIM, and location information of the target VM allocated by the target VIM.

With reference to the first aspect of the embodiments of the present invention to the third implementation of the first aspect of the embodiments of the present invention, in a fourth implementation of the first aspect of the embodiments of the present invention,

the information about the target VIM includes any combination of the following information:

an identifier of the target VIM, and configuration information for establishing a connection to the target VIM.

With reference to the first aspect of the embodiments of the present invention, in a fifth implementation of the first aspect of the embodiments of the present invention,

the method further includes: when the resource of the target VIM connected to the second VNFM cannot meet the information about the resource that is applied for, receiving, by the first VNFM, a second feedback message sent by the second VNFM, where

the second feedback message is used to indicate that the resource of the target VIM connected to the second VNFM cannot meet the information about the resource that is applied for.

With reference to the fifth implementation of the first aspect of the embodiments of the present invention, in a sixth implementation of the first aspect of the embodiments of the present invention,

the second feedback message includes resource information of a remaining resource of the target VIM connected to the second VNFM, and the resource information of the remaining resource includes a resource type of the remaining resource and a resource amount of the remaining resource.

With reference to the sixth implementation of the first aspect of the embodiments of the present invention, in a seventh implementation of the first aspect of the embodiments of the present invention,

the method further includes:

sending, by the first VNFM, a second resource request message to the second VNFM, where the second resource request message includes resource information of a reallocation resource, and the remaining resource is used by the target VIM to reserve the reallocation resource for or allocate the reallocation resource to the first VNFM.

With reference to the method according to any one of the first aspect of the embodiments of the present invention to the seventh implementation of the first aspect of the embodiments of the present invention, in an eighth implementation of the first aspect of the embodiments of the present invention,

the information about the resource that is applied for includes a type of the resource that is applied for and an amount of the resource that is applied for.

A second aspect of the embodiments of the present invention provides a network functions virtualization resource processing method, including:

receiving, by a second VNFM, a first resource request message sent by a first VNFM, where the first resource request message includes information about a resource for which the first VNFM applies for a virtualized network function VNF; and

when a resource of a target virtualized infrastructure manager VIM connected to the second VNFM meets the information about the resource that is applied for, sending, by the second VNFM, a first feedback message to the first VNFM, where the first feedback message includes information about the target VIM that has reserved a resource for or allocated a resource to the first VNFM.

With reference to the second aspect of the embodiments of the present invention, in a first implementation of the second aspect of the embodiments of the present invention,

before the sending, by the second VNFM, a first feedback message to the first VNFM, the method further includes:

sending, by the second VNFM, a resource reservation message to the target VIM; and

receiving, by the second VNFM, a resource reservation feedback message sent by the target VIM.

With reference to the first implementation of the second aspect of the embodiments of the present invention, in a second implementation of the second aspect of the embodiments of the present invention,

the resource reservation message includes a resource reservation identifier, the first feedback message includes the resource reservation identifier, and the resource reservation identifier is used to identify the reserved resource.

With reference to the second aspect of the embodiments of the present invention, in a third implementation of the second aspect of the embodiments of the present invention,

before the sending, by the second VNFM, a first feedback message to the first VNFM, the method further includes:

sending, by the second VNFM, a second resource allocation message to the target VIM; and

receiving, by the second VNFM, a resource allocation feedback message sent by the target VIM.

With reference to the second aspect of the embodiments of the present invention, in a fourth implementation of the second aspect of the embodiments of the present invention,

the first feedback message further includes any combination of the following information: an identifier of a target virtual machine VM allocated by the target VIM, and location information of the target VM allocated by the target VIM.

With reference to the method according to any one of the second aspect of the embodiments of the present invention to the fourth implementation of the second aspect of the embodiments of the present invention, in a fifth implementation of the second aspect of the embodiments of the present invention,

the information about the target VIM includes any combination of the following information:

an identifier of the target VIM, and configuration information for establishing a connection to the target VIM.

With reference to the second aspect of the embodiments of the present invention, in a sixth implementation of the second aspect of the embodiments of the present invention,

the method further includes: when the resource of the target VIM connected to the second VNFM cannot meet the information about the resource that is applied for, sending, by the second VNFM, a second feedback message to the first VNFM, where

the second feedback message is used to indicate that the resource of the target VIM connected to the second VNFM cannot meet the information about the resource that is applied for.

With reference to the sixth implementation of the second aspect of the embodiments of the present invention, in a seventh implementation of the second aspect of the embodiments of the present invention,

when the resource of the target VIM connected to the second VNFM cannot meet the information about the resource that is applied for, the second feedback message includes resource information of a remaining resource of the target VIM connected to the second VNFM, and the resource information of the remaining resource includes a resource type of the remaining resource and a resource amount of the remaining resource.

With reference to the seventh implementation of the second aspect of the embodiments of the present invention, in an eighth implementation of the second aspect of the embodiments of the present invention,

the method further includes:

receiving, by the second VNFM, a second resource request message sent by the first VNFM, where the second resource request message includes resource information of a reallocation resource, and the remaining resource is used by the target VIM to reserve the reallocation resource for or allocate the reallocation resource to the first VNFM.

With reference to the method according to any one of the second aspect of the embodiments of the present invention to the eighth implementation of the second aspect of the embodiments of the present invention, in a ninth implementation of the second aspect of the embodiments of the present invention,

the information about the resource that is applied for includes a type of the resource that is applied for and an amount of the resource that is applied for.

A third aspect of the embodiments of the present invention provides a virtualized network function manager VNFM, including:

a sending unit, configured to send a first resource request message to a second VNFM, where the first resource request message includes information about a resource for which the VNFM applies for a virtualized network function VNF; and

a receiving unit, configured to: when a resource of a target virtualized infrastructure manager VIM connected to the second VNFM meets the information about the resource that is applied for, receive a first feedback message sent by the second VNFM, where the first feedback message includes information about the target VIM that has reserved a resource for or allocated a resource to the VNFM.

With reference to the third aspect of the embodiments of the present invention, in a first implementation of the third aspect of the embodiments of the present invention, the VNFM further includes:

a determining unit, configured to determine that the first feedback message includes the information about the target VIM that has reserved a resource for the VNFM, where

the sending unit is further configured to: when the first feedback message includes the information about the target VIM that has reserved a resource for the VNFM, send a first resource allocation message to the target VIM, where the first resource allocation message is used by the target VIM to allocate the resource that is applied for.

With reference to the first implementation of the third aspect of the embodiments of the present invention, in a second implementation of the third aspect of the embodiments of the present invention,

the first feedback message received by the receiving unit includes a resource reservation identifier, the first resource allocation message sent by the sending unit includes the resource reservation identifier, and the resource reservation identifier is used to identify the reserved resource.

With reference to the third aspect of the embodiments of the present invention, in a third implementation of the third aspect of the embodiments of the present invention,

the VNFM further includes: a determining unit, configured to determine that the first feedback message includes the information about the target VIM that has allocated a resource to the VNFM, where the first feedback message further includes any combination of the following information: an identifier of a target virtual machine VM allocated by the target VIM, and location information of the target VM.

With reference to the VNFM according to any one of the third aspect of the embodiments of the present invention to the third implementation of the third aspect of the embodiments of the present invention, in a fourth implementation of the third aspect of the embodiments of the present invention,

the information about the target VIM that is received by the receiving unit includes any combination of the following information:

an identifier of the target VIM, and configuration information for establishing a connection to the target VIM.

With reference to the third aspect of the embodiments of the present invention, in a fifth implementation of the third aspect of the embodiments of the present invention,

the receiving unit is further configured to: when the resource of the target VIM connected to the second VNFM cannot meet the information about the resource that is applied for, receive a second feedback message sent by the second VNFM, where

the second feedback message is used to indicate that the resource of the target VIM connected to the second VNFM cannot meet the information about the resource that is applied for.

With reference to the fifth implementation of the third aspect of the embodiments of the present invention, in a sixth implementation of the third aspect of the embodiments of the present invention,

the second feedback message received by the receiving unit further includes resource information of a remaining resource of the target VIM connected to the second VNFM, and the resource information of the remaining resource includes a resource type of the remaining resource and a resource amount of the remaining resource.

With reference to the sixth implementation of the third aspect of the embodiments of the present invention, in a seventh implementation of the third aspect of the embodiments of the present invention,

the sending unit is further configured to send a second resource request message to the second VNFM, where the second resource request message includes resource information of a reallocation resource, and the remaining resource is used by the target VIM to reserve the reallocation resource for or allocate the reallocation resource to the VNFM.

With reference to the VNFM according to any one of the third aspect of the embodiments of the present invention to the seventh implementation of the third aspect of the embodiments of the present invention, in an eighth implementation of the third aspect of the embodiments of the present invention,

the information about the resource that is applied for that is sent by the sending unit includes a type of the resource that is applied for and an amount of the resource that is applied for.

A fourth aspect of the embodiments of the present invention provides a virtualized network function manager VNFM, including:

a receiving unit, configured to receive a first resource request message sent by a first VNFM, where the first resource request message includes information about a resource for which the first VNFM applies for a virtualized network function VNF;

a determining unit, configured to determine that a resource of a target virtualized infrastructure manager VIM connected to the VNFM meets the information about the resource that is applied for; and

a sending unit, configured to: when the resource of the target virtualized infrastructure manager VIM connected to the VNFM meets the information about the resource that is applied for, send a first feedback message to the first VNFM, where the first feedback message includes information about the target VIM that has reserved a resource for or allocated a resource to the first VNFM.

With reference to the fourth aspect of the embodiments of the present invention, in a first implementation of the fourth aspect of the embodiments of the present invention,

the sending unit is further configured to send a resource reservation message to the target VIM; and

the receiving unit is further configured to receive a resource reservation feedback message sent by the target VIM.

With reference to the first implementation of the fourth aspect of the embodiments of the present invention, in a second implementation of the fourth aspect of the embodiments of the present invention,

the resource reservation message sent by the sending unit includes a resource reservation identifier, the first feedback message sent by the sending unit includes the resource reservation identifier, and the resource reservation identifier is used to identify the resource reserved by the target VIM, and allocate the resource that is applied for.

With reference to the fourth aspect of the embodiments of the present invention, in a third implementation of the fourth aspect of the embodiments of the present invention,

the sending unit is further configured to send a second resource allocation message to the target VIM; and

the receiving unit is further configured to receive a resource allocation feedback message sent by the target VIM.

With reference to the fourth aspect of the embodiments of the present invention, in a fourth implementation of the fourth aspect of the embodiments of the present invention,

the first feedback message sent by the sending unit further includes any combination of the following information: an identifier of a target virtual machine VM allocated by the target VIM, and location information of the target VM allocated by the target VIM.

With reference to the VNFM according to any one of the fourth aspect of the embodiments of the present invention to the fourth implementation of the fourth aspect of the embodiments of the present invention, in a fifth implementation of the fourth aspect of the embodiments of the present invention,

the information about the target VIM that is included in the first feedback message sent by the sending unit includes any combination of the following information:

an identifier of the target VIM, and configuration information for establishing a connection to the target VIM.

With reference to the fourth aspect of the embodiments of the present invention, in a sixth implementation of the fourth aspect of the embodiments of the present invention,

the determining unit is further configured to determine that the resource of the target VIM connected to the VNFM cannot meet the information about the resource that is applied for; and

the sending unit is further configured to: when the resource of the target VIM connected to the VNFM cannot meet the information about the resource that is applied for, send a second feedback message to the first VNFM, where the second feedback message is used to indicate that the resource of the target VIM connected to the VNFM cannot meet the information about the resource that is applied for.

With reference to the sixth implementation of the fourth aspect of the embodiments of the present invention, in a seventh implementation of the fourth aspect of the embodiments of the present invention,

the second feedback message sent by the sending unit includes resource information of a remaining resource of the target VIM connected to the VNFM, and the resource information of the remaining resource includes a resource type of the remaining resource and a resource amount of the remaining resource.

With reference to the seventh implementation of the fourth aspect of the embodiments of the present invention, in an eighth implementation of the fourth aspect of the embodiments of the present invention,

the receiving unit is further configured to receive a second resource request message sent by the first VNFM, where the second resource request message includes resource information of a reallocation resource, and the remaining resource is used by the target VIM to reserve the reallocation resource for or allocate the reallocation resource to the first VNFM.

With reference to the VNFM according to any one of the fourth aspect of the embodiments of the present invention to the eighth implementation of the fourth aspect of the embodiments of the present invention, in a ninth implementation of the fourth aspect of the embodiments of the present invention,

the information about the resource that is applied for that is received by the receiving unit includes a type of the resource that is applied for and an amount of the resource that is applied for.

A fifth aspect of the embodiments of the present invention provides a virtualized network function manager VNFM, including:

a transmitter, configured to send a first resource request message to a second VNFM, where the first resource request message includes information about a resource for which the VNFM applies for a virtualized network function VNF; and

a receiver, configured to: when a resource of a target virtualized infrastructure manager VIM connected to the second VNFM meets the information about the resource that is applied for, receive a first feedback message sent by the second VNFM, where the first feedback message includes information about the target VIM that has reserved a resource for or allocated a resource to the VNFM.

With reference to the fifth aspect of the embodiments of the present invention, in a first implementation of the fifth aspect of the embodiments of the present invention,

the VNFM further includes a processor, where

the processor is configured to determine that the first feedback message includes the information about the target VIM that has reserved a resource for the VNFM; and

the transmitter is further configured to: when the first feedback message includes the information about the target VIM that has reserved a resource for the VNFM, send a first resource allocation message to the target VIM, where the first resource allocation message is used by the target VIM to allocate the resource that is applied for.

With reference to the first implementation of the fifth aspect of the embodiments of the present invention, in a second implementation of the fifth aspect of the embodiments of the present invention,

the first feedback message received by the receiver includes a resource reservation identifier, the first resource allocation message sent by the transmitter includes the resource reservation identifier, and the resource reservation identifier is used to identify the reserved resource.

With reference to the fifth aspect of the embodiments of the present invention, in a third implementation of the fifth aspect of the embodiments of the present invention,

the VNFM further includes a processor, where

the processor is configured to determine that the first feedback message includes the information about the target VIM that has allocated a resource to the VNFM, where the first feedback message further includes any combination of the following information: an identifier of a target virtual machine VM allocated by the target VIM, and location information of the target VM.

With reference to the fifth aspect of the embodiments of the present invention to the third implementation of the fifth aspect of the embodiments of the present invention, in a fourth implementation of the fifth aspect of the embodiments of the present invention,

the information about the target VIM that is received by the receiver includes any combination of the following information:

an identifier of the target VIM, and configuration information for establishing a connection to the target VIM.

With reference to the fifth aspect of the embodiments of the present invention, in a fifth implementation of the fifth aspect of the embodiments of the present invention,

the receiver is further configured to: when the resource of the target VIM connected to the second VNFM cannot meet the information about the resource that is applied for, receive a second feedback message sent by the second VNFM, where

the second feedback message is used to indicate that the resource of the target VIM connected to the second VNFM cannot meet the information about the resource that is applied for.

With reference to the fifth implementation of the fifth aspect of the embodiments of the present invention, in a sixth implementation of the fifth aspect of the embodiments of the present invention,

the second feedback message received by the receiver further includes resource information of a remaining resource of the target VIM connected to the second VNFM, and the resource information of the remaining resource includes a resource type of the remaining resource and a resource amount of the remaining resource.

With reference to the sixth implementation of the fifth aspect of the embodiments of the present invention, in a seventh implementation of the fifth aspect of the embodiments of the present invention,

the transmitter is further configured to send a second resource request message to the second VNFM, where the second resource request message includes resource information of a reallocation resource, and the remaining resource is used by the target VIM to reserve the reallocation resource for or allocate the reallocation resource to the VNFM.

With reference to the VNFM according to any one of the fifth aspect of the embodiments of the present invention to the seventh implementation of the fifth aspect of the embodiments of the present invention, in an eighth implementation of the fifth aspect of the embodiments of the present invention,

the information about the resource that is applied for that is sent by the transmitter includes a type of the resource that is applied for and an amount of the resource that is applied for.

A sixth aspect of the embodiments of the present invention provides a virtualized network function manager VNFM, including:

a receiver, configured to receive a first resource request message sent by a first VNFM, where the first resource request message includes information about a resource for which the first VNFM applies for a virtualized network function VNF;

a processor, configured to determine that a resource of a target virtualized infrastructure manager VIM connected to the VNFM meets the information about the resource that is applied for; and

a transmitter, configured to: when the resource of the target virtualized infrastructure manager VIM connected to the VNFM meets the information about the resource that is applied for, send a first feedback message to the first VNFM, where the first feedback message includes information about the target VIM that has reserved a resource for or allocated a resource to the first VNFM.

With reference to the sixth aspect of the embodiments of the present invention, in a first implementation of the sixth aspect of the embodiments of the present invention,

the transmitter is further configured to send a resource reservation message to the target VIM; and

the receiver is further configured to receive a resource reservation feedback message sent by the target VIM.

With reference to the first implementation of the sixth aspect of the embodiments of the present invention, in a second implementation of the sixth aspect of the embodiments of the present invention,

the resource reservation message sent by the transmitter includes a resource reservation identifier, the first feedback message sent by the transmitter includes the resource reservation identifier, and the resource reservation identifier is used to identify the resource reserved by the target VIM, and allocate the resource that is applied for.

With reference to the sixth aspect of the embodiments of the present invention, in a third implementation of the sixth aspect of the embodiments of the present invention,

the transmitter is further configured to send a second resource allocation message to the target VIM; and

the receiver is further configured to receive a resource allocation feedback message sent by the target VIM.

With reference to the sixth aspect of the embodiments of the present invention, in a fourth implementation of the sixth aspect of the embodiments of the present invention,

the first feedback message sent by the transmitter further includes any combination of the following information: an identifier of a target virtual machine VM allocated by the target VIM, and location information of the target VM allocated by the target VIM.

With reference to the VNFM according to any one of the sixth aspect of the embodiments of the present invention to the fourth implementation of the sixth aspect of the embodiments of the present invention, in a fifth implementation of the sixth aspect of the embodiments of the present invention,

the information about the target VIM that is included in the first feedback message sent by the transmitter includes any combination of the following information:

an identifier of the target VIM, and configuration information for establishing a connection to the target VIM.

With reference to the sixth aspect of the embodiments of the present invention, in a sixth implementation of the sixth aspect of the embodiments of the present invention,

the processor is further configured to determine that the resource of the target VIM connected to the VNFM cannot meet the information about the resource that is applied for; and

the transmitter is further configured to: when the resource of the target VIM connected to the VNFM cannot meet the information about the resource that is applied for, send a second feedback message to the first VNFM, where the second feedback message is used to indicate that the resource of the target VIM connected to the VNFM cannot meet the information about the resource that is applied for.

With reference to the sixth implementation of the sixth aspect of the embodiments of the present invention, in a seventh implementation of the sixth aspect of the embodiments of the present invention,

the second feedback message sent by the transmitter includes resource information of a remaining resource of the target VIM connected to the VNFM, and the resource information of the remaining resource includes a resource type of the remaining resource and a resource amount of the remaining resource.

With reference to the seventh implementation of the sixth aspect of the embodiments of the present invention, in an eighth implementation of the sixth aspect of the embodiments of the present invention,

the receiver is further configured to receive a second resource request message sent by the first VNFM, where the second resource request message includes resource information of a reallocation resource, and the remaining resource is used by the target VIM to reserve the reallocation resource for or allocate the reallocation resource to the first VNFM.

With reference to the VNFM according to any one of the sixth aspect of the embodiments of the present invention to the eighth implementation of the sixth aspect of the embodiments of the present invention, in a ninth implementation of the sixth aspect of the embodiments of the present invention,

the information about the resource that is applied for that is received by the receiver includes a type of the resource that is applied for and an amount of the resource that is applied for.

The present invention provides a network functions virtualization resource processing method and a virtualized network function manager. When determining that the first VNFM needs to apply for a resource for the virtualized network function VNF, the first VNFM sends, without using an NFVO, the first resource request message for requesting a resource to the second VNFM connected to the first VNFM. The first resource request message includes the information about the resource for which the first VNFM applies for the VNF. When the resource of the target VIM connected to the second VNFM meets the information about the resource that is applied for, the first VNFM determines, according to the received first feedback message, the information about the target VIM that can reserve a resource for or allocate a resource to the first VNFM. It can be learned that a distributed resource management manner is implemented in a resource processing process described in the embodiments. Therefore, when the NFVO is faulty, the first VNFM can still apply for a resource for the virtualized network function VNF, thereby effectively improving robustness and efficiency of a network.

### BRIEF DESCRIPTION OF DRAWINGS

FIG. 1 is a schematic architectural diagram of an NFV system according to an embodiment of the present invention;

FIG. 2 is a local schematic structural diagram of an NFV system according to an embodiment of the present invention;

FIG. 3 is a step flowchart of a network functions virtualization resource processing method according to Embodiment 1 of the present invention;

FIG. 4 is a step flowchart of a network functions virtualization resource processing method according to Embodiment 2 of the present invention;

FIG. 5A and FIG. 5B are a step flowchart of a network functions virtualization resource processing method according to Embodiment 3 of the present invention;

FIG. 6 is a step flowchart of a network functions virtualization resource processing method according to Embodiment 4 of the present invention;

FIG. 7A and FIG. 7B are a step flowchart of a network functions virtualization resource processing method according to Embodiment 5 of the present invention;

FIG. 8 is a schematic structural diagram of a virtualized network function manager VNFM according to Embodiment 6 of the present invention;

FIG. 9 is a schematic structural diagram of a virtualized network function manager VNFM according to Embodiment 7 of the present invention;

FIG. 10 is a schematic structural diagram of a virtualized network function manager

VNFM according to Embodiment 8 of the present invention; and

FIG. 11 is a schematic structural diagram of a virtualized network function manager VNFM according to Embodiment 9 of the present invention.

### DESCRIPTION OF EMBODIMENTS

The following clearly describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

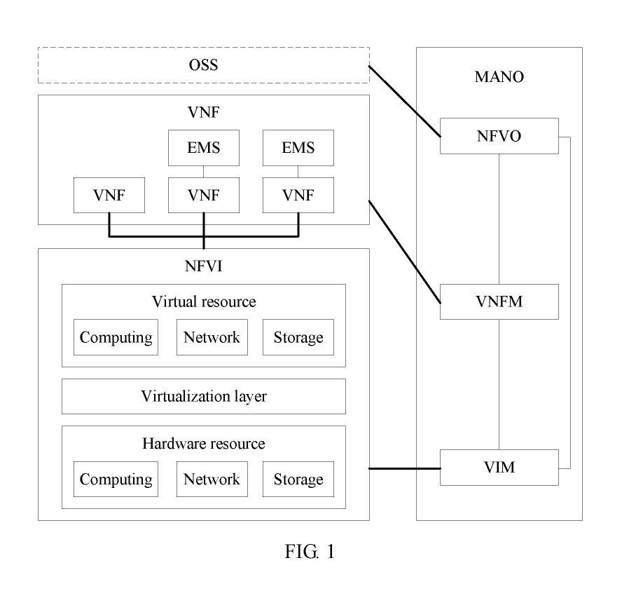

FIG. 1 is an architectural diagram of an NFV system in the prior art. Referring to FIG. 1, an NFV end-to-end architecture defined in an existing standard mainly includes three parts: a virtualized network function (VNF), an NFV infrastructure (NFVI), and management and orchestration (MANO).

VNF refers to virtualized network function, and corresponds to a physical network function on a conventional network.

The NFVI provides hardware and a virtual resource for operation of the entire system, and includes a hardware resource (including three parts: computing, a network, and storage), a virtualization layer (which virtualizes the hardware resource into a resource pool), and the virtual resource (also including three parts: computing, a network, and storage).

The MANO includes: an NFV orchestrator (NFVO), a VNF manager (VNFM), and a virtualized infrastructure manager (VIM).

The NFVO is responsible for lifecycle management of a network service (NS, a service unit including multiple VNFs), and management and orchestration of resources (including the hardware resource and a software resource) of the entire NFV system.

The VNFM is responsible for lifecycle management of the VNF.

The VIM is responsible for managing the NFVI.

The VNF is equipped with an element management system (EMS) to manage the VNF.

In addition, an operation support system (OSS) may manage the entire NFV system by using the NFVO.

For better understanding of the embodiments of the present invention, based on FIG. 1, a network functions virtualization NFV system is first described in the embodiments of the present invention.

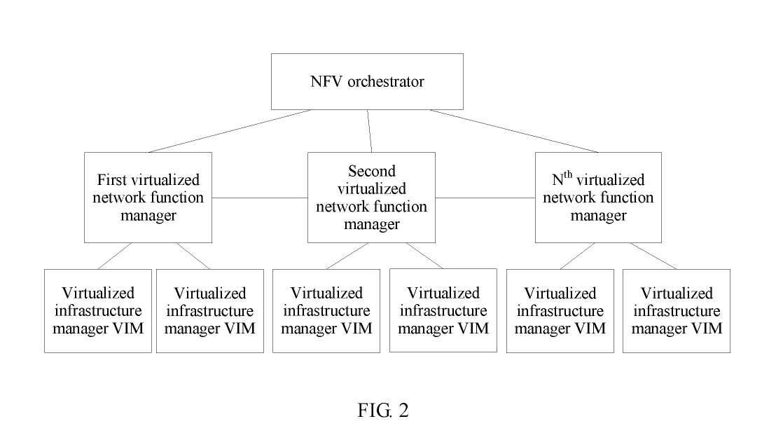

FIG. 2 is a local schematic structural diagram of an NFV system that can implement a network functions virtualization resource processing method according to an embodiment of the present invention.

It should be noted that FIG. 2 is a schematic architectural diagram of the NFV system according to the embodiment of the present invention, but does not impose limitations.

In an example in FIG. 2, the NFV system includes:

an NFV orchestrator and multiple VNFMs connected to the NFV orchestrator.

For a detailed description of the NFV orchestrator and the VNFMs, refer to descriptions of FIG. 1. Details are not described again in this embodiment.

It should be noted that a quantity of VNFMs included in a management domain of the NFV orchestrator is not limited in this embodiment.

Optionally, all the VNFMs in the management domain of the NFV orchestrator are connected to the NFVO.

In this embodiment, a first VNFM is connected to a second VNFM, so that a message can be transmitted between the first VNFM and the second VNFM.

Optionally, the first VNFM and the second VNFM are connected by using an interface.

In this embodiment, the first VNFM may be connected to the second VNFM, and the first VNFM may also be connected to an N^{th} VNFM. A specific value of N is not limited in this embodiment.

A management domain of each VNFM includes multiple virtualized infrastructure managers VIMs.

A specific quantity of VIMs included in the management domain of each VNFM is not limited in this embodiment.

In an example in FIG. 2, two VIMs are set to be connected to the first VNFM, and two VIMs are set to be connected to the second VNFM.

The VIM described in this embodiment can allocate or reserve, according to an instruction of the VNFM, a resource that is applied for for a virtualized network function VNF.

The following describes in detail the network functions virtualization resource processing method provided in the present invention with reference to specific embodiments.

### Embodiment 1

The following describes in detail Embodiment 1 with reference to FIG. 3. FIG. 3 is a flowchart of a network functions virtualization resource processing method according to Embodiment 1 of the present invention.

301. A first virtualized network function manager VNFM sends a first resource request message to a second VNFM.

In this embodiment, the first VNFM is already connected to the second VNFM, so that the first VNFM can send the first resource request message to the second VNFM.

It should be noted that a description is provided in this embodiment by using an example in which the first VNFM and the second VNFM that are connected to each other are located in a management domain of one NFVO. No limitation is imposed thereon.

In another optional application scenario, alternatively, the first VNFM and the second VNFM that are connected to each other may be located in management domains of two different NFVOs, provided that the first VNFM can send the first resource request message to the second VNFM.

This embodiment sets no limitation on the first resource request message, provided that the first resource request message includes information about a resource for which the first VNFM applies for a virtualized network function VNF.

In this embodiment, the first VNFM notifies the second VNFM by using the first resource request message, and the first resource request message includes the information about the resource for which the first VNFM applies for the VNF.

This embodiment sets no limitation on specific content of the information about the resource for which the first VNFM applies for the VNF, provided that the second VNFM determines, according to the information about the resource that is applied for, whether a virtualized infrastructure manager VIM connected to the second VNFM can allocate the resource for which the first VNFM applies for the VNF.

302. When a resource of a target virtualized infrastructure manager VIM connected to the second VNFM meets information about a resource that is applied for, the first VNFM receives a first feedback message sent by the second VNFM.

In this embodiment, when the resource of the target VIM meets the information about the resource for which the first VNFM applies for the VNF, the first VNFM can determine, according to the first feedback message sent by the second VNFM, information about the target VIM that has reserved a resource for or allocated a resource to the first VNFM.

This embodiment sets no limitation on the first feedback message, provided that the first VNFM can determine, according to the first feedback message, the information about the target VIM that has reserved a resource for or allocated a resource to the first VNFM.

According to the network functions virtualization resource processing method described in this embodiment, when the first VNFM determines that resource allocation needs to be performed, the first VNFM sends the first resource request message to the second VNFM. When the resource of the target VIM connected to the second VNFM meets the information about the resource that is applied for, the first VNFM determines, according to the received first feedback message, the information about the target VIM that can reserve or allocate the resource that is applied for. It can be learned that, in a resource processing process in this embodiment, a resource management network is formed between the first VNFM and the second VNFM, so that the VNFMs can perform resource processing such as resource query or resource allocation between each other. This process does not require participation of an NFVO. Therefore, impact on the network if the NFVO is faulty is avoided, and a distributed resource management manner is implemented, effectively improving robustness and efficiency of the network.

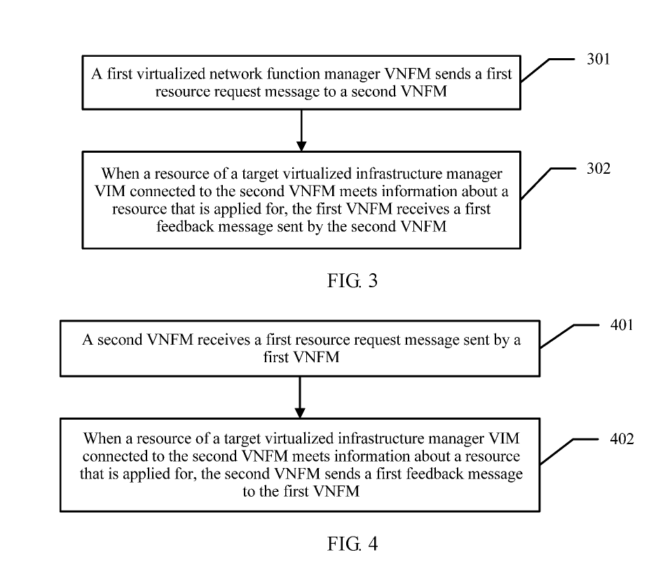

Embodiment 1 shown in FIG. 3 describes the network functions virtualization resource processing method from an angle of the first VNFM. The following describes the network functions virtualization resource processing method from an angle of the second VNFM with reference to Embodiment 2 shown in FIG. 4.

### Embodiment 2

401. A second VNFM receives a first resource request message sent by a first VNFM.

The first resource request message includes information about a resource for which the first VNFM applies for a virtualized network function VNF.

The second VNFM in this embodiment is a VNFM that is connected to the first VNFM and that can send/receive a message to/from the first VNFM. The second VNFM and the first VNFM may be located in a management domain of a same NFVO, or may be located in management domains of different NFVOs. This embodiment sets no specific limitation.

This embodiment sets no limitation on the first resource request message, provided that the second VNFM can determine, after receiving the first resource request message, whether a VIM connected to the second VNFM can allocate a resource that is applied for.

402. When a resource of a target virtualized infrastructure manager VIM connected to the second VNFM meets information about a resource that is applied for, the second VNFM sends a first feedback message to the first VNFM.

In this embodiment, when the second VNFM determines that a resource of a target VIM connected to the second VNFM meets the information about the resource that is applied for, the second VNFM sends the first feedback message to the first VNFM.

The first feedback message includes information about the target VIM that has reserved a resource for or allocated a resource to the first VNFM.

According to the network functions virtualization resource processing method described in this embodiment, the second VNFM can receive, without using an NFVO, the first resource request message sent by the first VNFM. When the resource of the target VIM connected to the second VNFM meets the information about the resource for which the first VNFM applies for the VNF, the second VNFM sends the first feedback message to the first VNFM. The first VNFM can determine, according to the received first feedback message, the information about the target VIM that has reserved a resource for or allocated a resource to the first VNFM. It can be learned that a resource management network is formed between the first VNFM and the second VNFM in a resource processing process in this embodiment, so that the VNFMs can perform resource processing such as resource query or resource allocation between each other. A specific processing process does not require participation of the NFVO. Therefore, impact on the network if the NFVO is faulty is avoided, and a distributed resource management manner is implemented. Further, when the NFVO is faulty, the second VNFM can still reserve or allocate the resource that is applied for, effectively improving robustness and efficiency of the network.

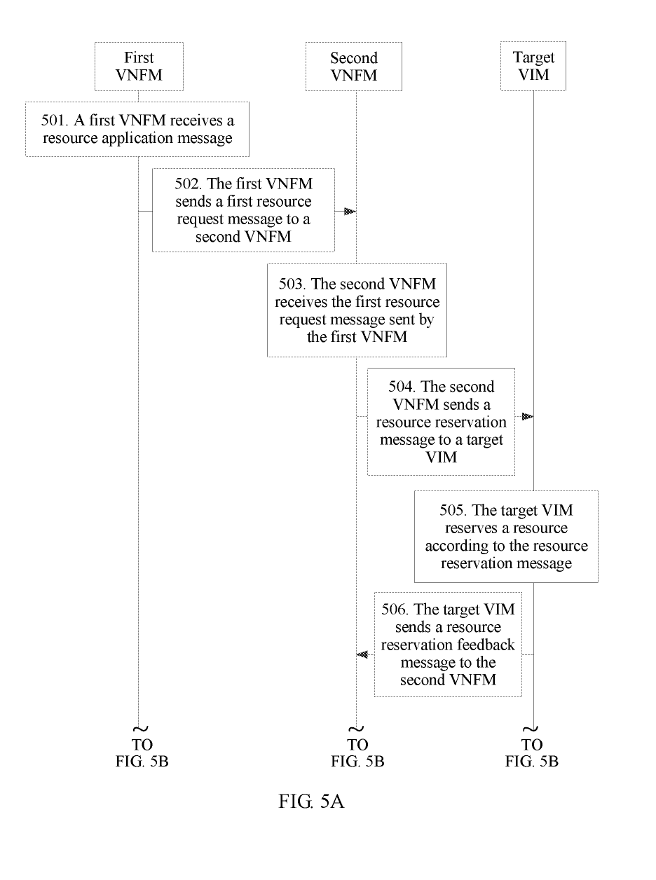

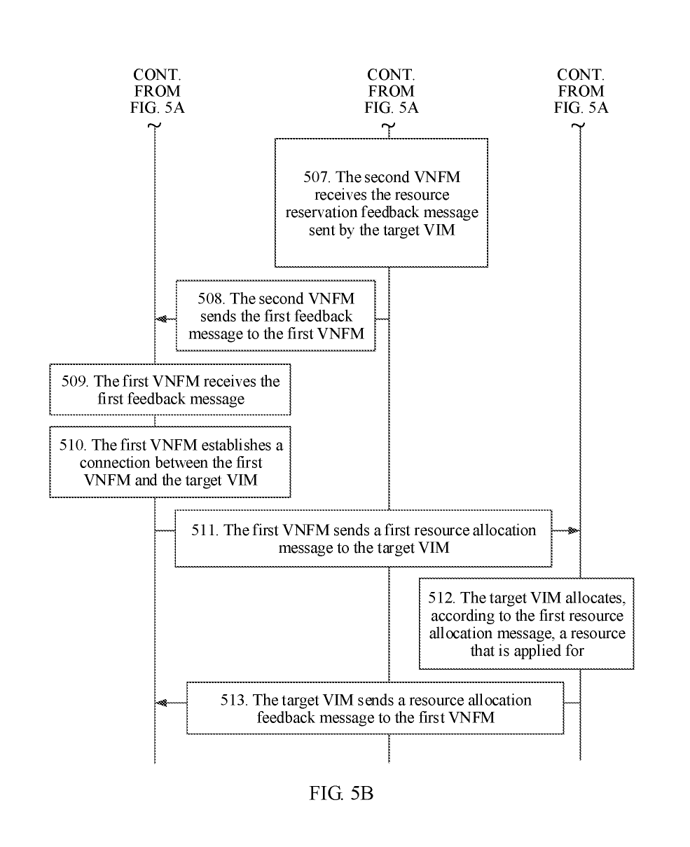

On a basis of Embodiment 1 and Embodiment 2, with reference to Embodiment 3 shown in FIG. 5A and FIG. 5B, the following describes how the first VNFM and the second VNFM implement distributed resource management.

### Embodiment 3

501. A first VNFM receives a resource application message.

No limitation is set on the resource application message, provided that the first VNFM determines, according to the resource application message, that there is a functional entity applying to the first VNFM for a resource.

For example, the resource application message may be an instantiation request of a VNF, an expansion request of a VNF, or any request related to resource application.

The expansion request of a VNF is a request that is sent by the VNF by using the resource application message and that is used for applying to the first VNFM for resource increase for the VNF when a load of the VNF exceeds a specific threshold or when resource consumption (for example, CPU usage) exceeds a specific threshold.

This embodiment sets no limitation on a functional entity that sends the resource application message. For example, the functional entity that sends the resource application message may be a VNF, an element manager (EM) entity, or another functional entity that can initiate a related resource application operation.

Specifically, the first VNFM can determine, according to the resource application message, the resource that is applied for.

Optionally, the resource that is applied for includes a resource amount of the resource that is applied for and a resource type of the resource that is applied for.

502. The first VNFM sends a first resource request message to a second VNFM.

Optionally, in this embodiment, the first VNFM sends the first resource request message according to resource information of a remaining resource of a VIM connected to the first VNFM.

Specifically, the first VNFM may check the resource information of the remaining resource of the VIM connected to the first VNFM. The resource information of the remaining resource described in this embodiment may include a resource amount of the remaining resource and a resource type of the remaining resource.

The resource type of the remaining resource determined by the first VNFM matches a resource type of the resource that is applied for.

The VIM that is connected to the first VNFM and that is described in this embodiment may be a VIM that has a resource information exchange (such as query, update, management, reservation, or allocation) relationship with the first VNFM.

Optionally, the first VNFM may be physically connected to the VIM, but no resource management relationship is triggered.

This embodiment sets no limitation on how the first VNFM specifically checks the resource information of the remaining resource of the VIM connected to the first VNFM, provided that the first VNFM can determine the resource information of the remaining resource of the VIM connected to the first VNFM.

The following describes an example of a manner in which the first VNFM determines the resource information of the remaining resource of the VIM connected to the first VNFM.

This embodiment provides two manners in which the first VNFM determines the resource information of the remaining resource.

In a first manner, the first VNFM stores a resource list.

The resource list stores resource information of a remaining resource of a VIM that has a resource management relationship with the first VNFM. When the first VNFM needs to determine the resource information of the remaining resource, the first VNFM directly queries the resource list.

Specifically, the resource information of the remaining resource that is stored in the resource list may be obtained by the first VNFM from the VIM. Alternatively, the VIM connected to the first VNFM periodically or aperiodically reports the resource information of the remaining resource to the first VNFM. Alternatively, the VIM that is connected to the first VNFM reports the resource information of the remaining resource of the VIM to the first VNFM when a trigger event is met, and the trigger event may be an event that a resource managed by the VIM connected to the first VNFM changes.

In a second manner, after the first VNFM receives the resource application message, the first VNFM may send a resource query message to the VIM connected to the first VNFM, so that the VIM connected to the first VNFM sends a resource response message, and indicates the resource information of the remaining resource of the VIM by using the resource response message.

It should be noted that some VNFs may allocate resources across VIMs. In this case, only a total of remaining resources of all VIMs managed by the first VNFM needs to meet a requirement. However, some VNFs cannot allocate resources across VIMs. In this case, if a remaining resource of each VIM managed by the first VNFM cannot meet the requirement, the first resource request message needs to be sent.

It can be learned that if the first VNFM determines that the resource amount of the remaining resource of the VIM connected to the first VNFM is less than the resource amount of the resource that is applied for, the first VNFM sends the first resource request message, so that the first VNFM can request, by using the first resource request message, a resource from another VNFM connected to the first VNFM.

For example, the first VNFM determines to apply for a resource of 4 GB vRAM, 2 vCPU, and 32 GB virtual storage. However, the first VNFM determines the remaining resource of the VIM connected to the first VNFM is 2 GB vRAM, 1 vCPU, and 28 GB virtual storage. The first VNFM may determine that the VIM connected to the first VNFM cannot allocate the resource that is applied for, and the first VNFM may send the first resource request message.

It should be noted that 501 and 502 in this embodiment are optional. Limitation is not imposed thereon.

For example, alternatively, the first VNFM may send the first resource request message without querying the resource information of the remaining resource of the VIM connected to the first VNFM.

For another example, alternatively, the first VNFM may send the first resource request message when no resource application message is received and the resource information of the remaining resource of the VIM connected to the first VNFM cannot meet a preconfigured resource management threshold. The resource management threshold herein may be defined as a specific amount that a resource managed by a VNFM needs to meet. For example, the resource management threshold may be 10 GB vRAM, 8 vCPU, and 65 GB virtual storage.

The first resource request message includes information about a resource for which the first VNFM applies for the VNF.

The resource that is applied for described in this embodiment is a resource that the first VNFM requests a VIM connected to the second VNFM to allocate.

In this embodiment, the resource for which the first VNFM applies for the VNF may be all resources that are applied for. Alternatively, the resource for which the first VNFM applies for the VNF may be some of resources that are applied for.

If the resource for which the first VNFM applies for the VNF is all the resources that are applied for, the first VNFM can request, by using the first resource request message, the resource from the another VNFM connected to the first VNFM.

If the resource for which the first VNFM applies for the VNF is some of the resources that are applied for, the first VNFM may divide the resource that is applied for into two parts: a first resource that is applied for and a second resource that is applied for. The first resource that is applied for matches the remaining resource of the VIM connected to the first VNFM; and the first VNFM may allocate, by using the VIM connected to the first VNFM, the first resource that is applied for. In this case, the resource for which the first VNFM applies for the VNF is the second resource that is applied for. That is, the first VNFM may request, by using the first resource request message, the VIM connected to the second VNFM, to allocate the second resource that is applied for.

Specifically, the information about the resource for which the first VNFM applies for the VNF includes a resource type and a resource amount of the resource that is applied for for the VNF.

More specifically, the first resource request message may further carry the following information: a related policy of the resource that is applied for, for example, affinity/anti-affinity.

503. The second VNFM receives the first resource request message sent by the first VNFM.

504. The second VNFM sends a resource reservation message to a target VIM.

Specifically, the second VNFM determines a target VIM. A process in which the second VNFM determines the target VIM may be as follows:

After receiving the first resource request message, the second VNFM may query resource information of a remaining resource of the VIM connected to the second VNFM. The second VNFM determines that a VIM that is of the VIM connected to the second VNFM and that can allocate the resource that is applied for is the target VIM.

For example, a remaining resource of a VIM 4 connected to the second VNFM can be used to allocate the resource that is applied for, and the second VNFM may determine the VIM 4 as the target VIM.

This embodiment sets no limitation on the resource reservation message, provided that the resource reservation message can instruct the target VIM to reserve a resource for the resource that is applied for.

Specifically, the resource reservation message includes a resource reservation identifier, and the resource reservation identifier is used to identify the resource reserved by the target VIM, and allocate the resource that is applied for.

Optionally, the resource reservation message includes any combination of the following information: the resource reservation identifier, an identifier of the first VNFM, an identifier of the VNF to which a resource needs to be allocated, the type of the resource that is applied for, the amount of the resource that is applied for, the related policy of the resource that is applied for, and an identifier of the target VIM.

505. The target VIM reserves a resource according to the resource reservation message.

506. The target VIM sends a resource reservation feedback message to the second VNFM.

507. The second VNFM receives the resource reservation feedback message sent by the target VIM.

The second VNFM can determine, according to the resource reservation feedback message, that the target VIM has successfully reserved the resource.

When the target VIM has successfully reserved the resource, the second VNFM sends the first feedback message.

Specifically, information about the target VIM that is included in the first feedback message includes any combination of the following information: the identifier of the target VIM, and configuration information for establishing a connection to the target VIM.

It should be noted that the specific information included in the information about the target VIM is an example for description instead of a limitation, provided that the first VNFM can determine, according to the first feedback message, that the target VIM has successfully reserved the resource.

For example, the information about the target VIM may further include information about the resource reserved on the VIM, for example, a type of the resource and a corresponding resource amount.

More specifically, the first feedback message includes the resource reservation identifier.

508. The second VNFM sends the first feedback message to the first VNFM.

509. The first VNFM receives the first feedback message.

510. The first VNFM establishes a connection between the first VNFM and the target VIM.

Specifically, the first VNFM may establish the connection to the target VIM according to the first feedback message. More specifically, the first VNFM may establish the connection to the target VIM according to the information about the target VIM that is included in the first feedback message.

Certainly, in a specific application process of this embodiment, the identifier of the target VIM and/or the configuration information may be sent to the first VNFM by the second VNFM without using the first feedback message.

It should be noted that there is no time sequence relationship between 510 for establishing the connection between the first VNFM and the target VIM and 504 to 509. This embodiment is merely an example.

It should be further noted that if the first VNFM is already connected to the target VIM, 510 does not need to be performed.

It should be further noted that 510 for establishing the connection between the first VNFM and the target VIM is merely an example instead of a limitation. For example, alternatively, the first VNFM may further obtain configuration information from an NFVO connected to the first VNFM.

This embodiment sets no limitation on the configuration information, provided that the first VNFM can establish the connection between the first VNFM and the target VIM according to the configuration information.

For example, the configuration information includes an IP address of the target VIM.

Optionally, the configuration information may further include any combination of the following information: a uniform resource locator (URL) of the target VIM, a user name of the target VIM, an authentication password of the target VIM, and the like.

511. The first VNFM sends a first resource allocation message to the target VIM.

The first resource allocation message is used by the target VIM to allocate, according to the first resource allocation message, the resource that is applied for.

Specifically, the first resource allocation message includes the resource reservation identifier.

512. The target VIM allocates, according to the first resource allocation message, a resource that is applied for.

For example, the VIM performs resource allocation according to information about a previously reserved resource, including starting a virtual machine (VM).

513. The target VIM sends a resource allocation feedback message to the first VNFM.

Specifically, after receiving the first resource allocation message, the target VIM may determine, according to the resource reservation identifier included in the first resource allocation message, that the reserved resource is used to allocate the resource that is applied for.

The target VIM can allocate, by using the reserved resource, the resource that is applied for.

The target VIM may notify, by using the resource allocation feedback message, the first VNFM that the resource that is applied for has been successfully allocated.

Optionally, the first VNFM may further feed back a resource allocation status to the NFVO connected to the first VNFM.

Optionally, after the first VNFM receives the resource allocation feedback message sent by the target VIM, the first VNFM may further perform a related configuration operation on a related VNF. For example, if the resource application message is a VNF instantiation request, the first VNFM performs parameter configuration on the VNF; or if the resource application message is a VNF expansion request, the first VNFM updates parameter configuration of the VNF.

According to the network functions virtualization resource processing method described in this embodiment, a resource management network is formed between the first VNFM and the second VNFM, so that the VNFMs can perform resource processing such as resource query or resource allocation between each other. A specific processing process does not require participation of the NFVO. Therefore, impact on the network if the NFVO is faulty is avoided, and a distributed resource management manner is implemented. Further, when the NFVO is faulty, the second VNFM can still reserve or allocate the resource that is applied for, effectively improving robustness and efficiency of the network.

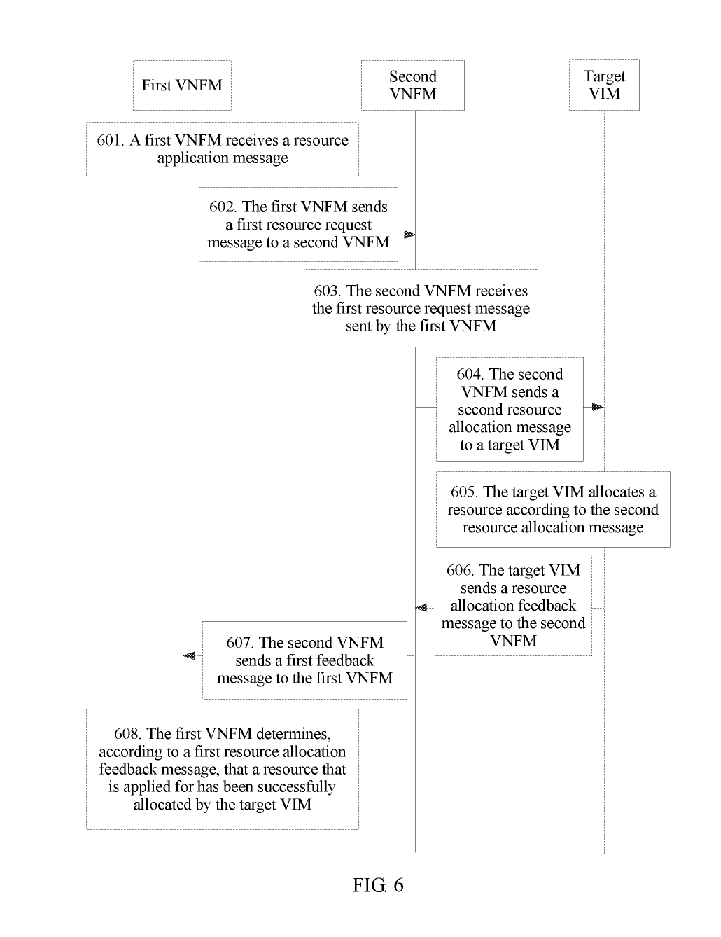

FIG. 5A and FIG. 5B show Embodiment 3 in which the second VNFM performs resource reservation on the resource for which the first VNFM applies for the VNF, and the first VNFM performs resource allocation on the resource that is applied for. With reference to Embodiment 4 shown in FIG. 6, the following describes how the second VNFM implements resource allocation on the resource that is applied for.

### Embodiment 4

601. A first VNFM receives a resource application message.

602. The first VNFM sends a first resource request message to a second VNFM.

603. The second VNFM receives the first resource request message sent by the first VNFM.

For details about specific processes of 601 to 603 described in this embodiment, refer to the descriptions of 501 to 503 shown in FIG. 5A and FIG. 5B. Details are not described again in this embodiment.

604. The second VNFM sends a second resource allocation message to a target VIM.

For details about a specific process of how the second VNFM determines the target VIM, refer to the embodiment shown in FIG. 4. Details are not described again in this embodiment.

In this embodiment, the second resource allocation message may include any combination of the following information: a type of a resource that is applied for, an amount of the resource that is applied for, and a related policy of the resource that is applied for.

605. The target VIM allocates a resource according to the second resource allocation message.

606. The target VIM sends a resource allocation feedback message to the second VNFM.

The target VIM may notify, by using the resource allocation feedback message, the second VNFM that the resource that is applied for has been successfully allocated. Optionally, the resource allocation feedback message may include an identifier of the target VIM and some configuration parameters such as a location of the allocated resource and connection information.

607. The second VNFM sends a first feedback message to the first VNFM.

The first feedback message includes information about the target VIM that has allocated a resource to the first VNFM, for example, the identifier of the target VIM, and information about the resource allocated by the target VIM. The information about the allocated resource includes a type of the allocated resource and an amount of the allocated resource.

The first feedback message may further include any combination of the following information: an identifier of a target virtual machine VM allocated by the target VIM, and location information of the target VM.

608. The first VNFM determines, according to a first resource allocation feedback message, that a resource that is applied for has been successfully allocated by the target VIM.

Optionally, the first VNFM may further feed back a resource allocation status to an NFVO connected to the first VNFM.

Optionally, after the first VNFM receives the resource allocation feedback message sent by the target VIM, the first VNFM may further perform a related configuration operation on a related VNF. For example, if the resource application message is a VNF instantiation request, the first VNFM performs parameter configuration on the VNF; or if the resource application message is a VNF expansion request, the first VNFM updates parameter configuration of the VNF.

According to the network functions virtualization resource processing method described in this embodiment, a resource management network is formed between the first VNFM and the second VNFM, so that the VNFMs can perform resource processing such as resource query or resource allocation between each other. A specific processing process does not require participation of the NFVO. Therefore, impact on the network if the NFVO is faulty is avoided, and a distributed resource management manner is implemented. Further, when the NFVO is faulty, the second VNFM can still reserve or allocate the resource that is applied for, effectively improving robustness and efficiency of the network.

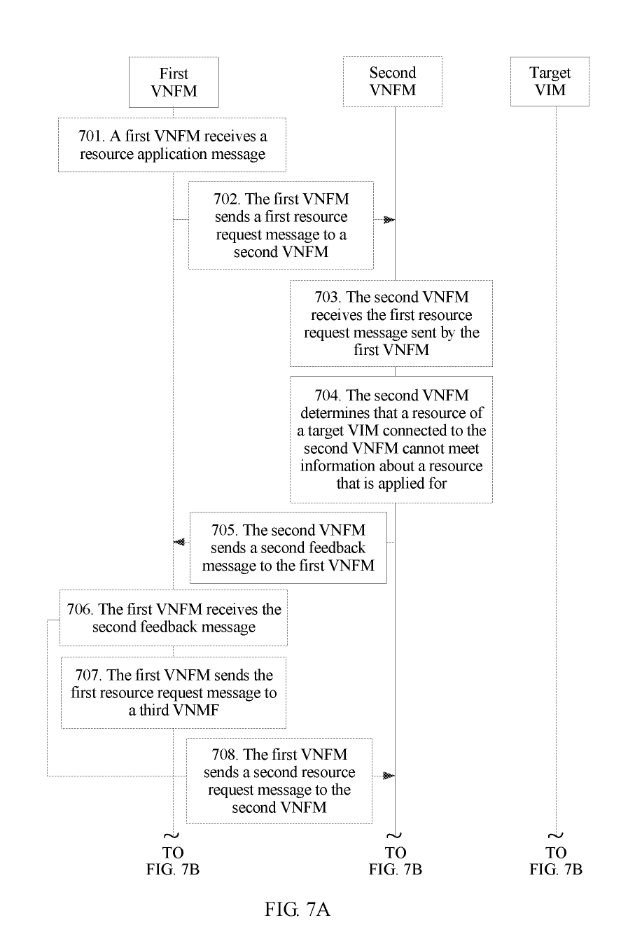

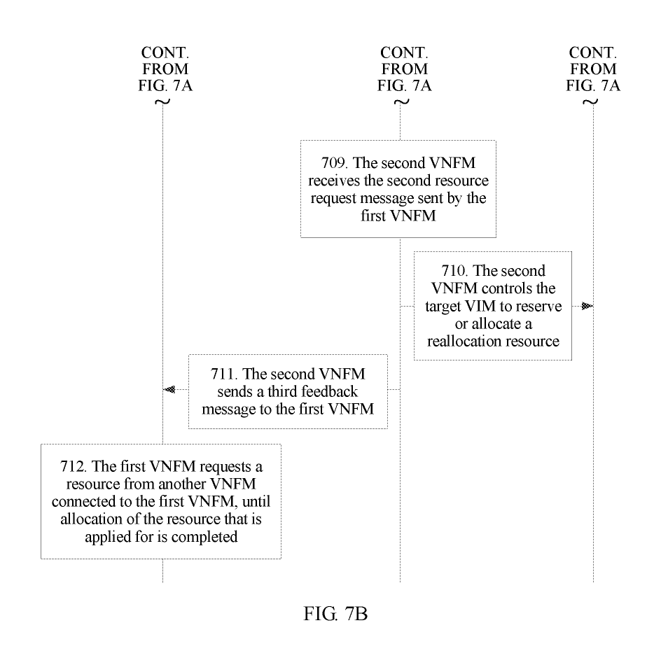

Embodiment 3 shown in FIG. 5A and FIG. 5B and Embodiment 4 shown in FIG. 6 describe how the network functions virtualization resource processing method is implemented when the resource of the target VIM connected to the second VNFM meets information about the resource that is applied for. With reference to Embodiment 5 shown in FIG. 7A and FIG. 7B, the following describes how to implement the network functions virtualization resource processing method if the resource of the target VIM connected to the second VNFM cannot meet the information about the resource that is applied for.

### Embodiment 5

701. A first VNFM receives a resource application message.

702. The first VNFM sends a first resource request message to a second VNFM.

703. The second VNFM receives the first resource request message sent by the first VNFM.

For specific processes of 701 to 703 described in this embodiment, refer to the descriptions of 501 to 503 shown in FIG. 5A. Details are not described again in this embodiment.

704. The second VNFM determines that a resource of a target VIM connected to the second VNFM cannot meet information about a resource that is applied for.

Specifically, after receiving the first resource request message, the second VNFM may query resource information of a remaining resource of the target VIM connected to the second VNFM.

In this embodiment, the target VIM connected to the second VNFM cannot allocate the resource that is applied for.

For example, a resource amount of the remaining resource of the target VIM is less than an amount of the resource that is applied for.

705. The second VNFM sends a second feedback message to the first VNFM.

The second feedback message is used to indicate that the resource of the target VIM connected to the second VNFM cannot meet the information about the resource that is applied for.

Specifically, the second feedback message further includes the resource information of the remaining resource of the target VIM connected to the second VNFM.

The resource information of the remaining resource of the target VIM includes a resource type of the remaining resource and a resource amount of the remaining resource.

706. The first VNFM receives the second feedback message.

If the first VNFM determines, according to the second feedback message, that the resource of the target VIM connected to the second VNFM cannot meet the information about the resource that is applied for, the first VNFM may continue to perform 707 or 708.

By performing 707, the first VNFM sends the first resource request message to a third VNFM connected to the first VNFM. If a resource of a VIM connected to the third VNFM cannot meet the information about the resource that is applied for, the first VNFM sends a first request message to another VNFM connected to the first VNFM, until the first resource request message is sent to a VNFM that meets the information about the resource that is applied for.

If the resource of the VIM connected to the third VNFM can meet the information about the resource that is applied for, the first VNFM requests the VIM connected to the third VNFM to reserve or allocate the resource that is applied for.

Optionally, the first VNFM may send the first resource request message to all VNFMs connected to the first VNFM, to select a VNFM that meets the information about the resource that is applied for.

Specifically, for a specific implementation process in which the VIM connected to the third VNFM reserves or allocates the resource that is applied for, refer to the foregoing-described process in which the target VIM connected to the second VNFM reserves or allocates the resource that is applied for. Details are not described herein again. By performing 708, the first VNFM can trigger the target VIM connected to the second VNFM to reserve or allocate a part of the resource that is applied for. For details, refer to descriptions of 708 to 712.

707. The first VNFM sends the first resource request message to a third VNFM.

708. The first VNFM sends a second resource request message to the second VNFM.

The second resource request message includes resource information of a reallocation resource.

The reallocation resource is a resource that is in the resource that is applied for and that matches the remaining resource.

Specifically, a resource amount of the reallocation resource is less than or equal to the resource amount of the remaining resource.

More specifically, the resource information of the reallocation resource includes a resource type of the reallocation resource and the resource amount of the reallocation resource.

709. The second VNFM receives the second resource request message sent by the first VNFM.

710. The second VNFM controls the target VIM to reserve or allocate a reallocation resource.

Specifically, the second VNFM reserves or allocates the reallocation resource according to the second resource request message.

If the second VNFM reserves the to-be-reallocated resource, for an implementation process in which the second VNFM reserves the to-be-reallocated resource, refer to the process shown in FIG. 4 in which the second VNFM reserves the resource that is applied for. Details are not described again in this embodiment.

If the second VNFM allocates the to-be-reallocated resource, for an implementation process in which the second VNFM allocates the to-be-reallocated resource, refer to the process shown in FIG. 5A and FIG. 5B in which the second VNFM allocates the resource that is applied for. Details are not described again in this embodiment.

711. The second VNFM sends a third feedback message to the first VNFM.

The third feedback message includes information about a VIM that has reserved or allocated a resource for the reallocation resource.

712. The first VNFM requests a resource from another VNFM connected to the first VNFM, until allocation of the resource that is applied for is completed.

It can be learned that in the foregoing , the resource that is applied for is allocated by using multiple VNFMs connected to the first VNFM.

According to the network functions virtualization resource processing method described in this embodiment, a resource management network is formed between the first VNFM and the second VNFM, so that the VNFMs can perform resource processing such as resource query or resource allocation between each other. A specific processing process does not require participation of an NFVO. Therefore, impact on the network if the NFVO is faulty is avoided, and a distributed resource management manner is implemented. Further, when the NFVO is faulty, the second VNFM can still reserve or allocate the resource that is applied for, effectively improving robustness and efficiency of the network.

With reference to Embodiment 6 shown in FIG. 8, the following describes in detail a specific structure of a virtualized network function manager VNFM provided in this embodiment of the present invention.

The VNFM described in this embodiment is configured to implement the method performed by the first VNFM in FIG. 3 and FIG. 5A and FIG. 5B to FIG. 7A and FIG. 7B.

The VNFM includes:

a sending unit 801, configured to send a first resource request message to a second VNFM, where the first resource request message includes information about a resource for which the VNFM applies for a virtualized network function VNF; and a receiving unit 802, configured to: when a resource of a target virtualized infrastructure manager VIM connected to the second VNFM meets the information about the resource that is applied for, receive a first feedback message sent by the second VNFM, where the first feedback message includes information about the target VIM that has reserved a resource for or allocated a resource to the VNFM.

The second VNFM described in this embodiment is a VNFM connected to the VNFM provided in this embodiment.

It should be noted that in this embodiment, a specific quantity of the sending units 801 and a specific quantity of the receiving units 802 are not limited. That is, there may be one or more sending units 801, and there may be one or more receiving units 802.

Optionally, as shown in FIG. 8, the VNFM in this embodiment further includes a determining unit 803.

When the second VNFM can reserve the resource that is applied for, the determining unit 803 is configured to determine that the first feedback message includes the information about the target VIM that has reserved a resource for the VNFM.

The sending unit 801 is further configured to: when the first feedback message includes the information about the target VIM that has reserved a resource for the VNFM, send a first resource allocation message to the target VIM, where the first resource allocation message is used by the target VIM to allocate the resource that is applied for.

Specifically, the first feedback message received by the receiving unit 802 includes a resource reservation identifier.

Specifically, the first resource allocation message sent by the sending unit 801 includes the resource reservation identifier, and the resource reservation identifier is used to identify the reserved resource.

When the second VNFM can allocate the resource that is applied for, the determining unit 803 is further configured to determine that the first feedback message includes the information about the target VIM that has allocated a resource to the VNFM. The first feedback message further includes any combination of the following information: an identifier of a target virtual machine VM allocated by the target VIM, and location information of the target VM.

The information about the target VIM that is received by the receiving unit 802 includes any combination of the following information: an identifier of the target VIM, and configuration information for establishing a connection to the target VIM.

If a resource of the VIM connected to the second VNFM cannot meet the information about the resource that is applied for, the receiving unit 802 is further configured to: when the resource of the target VIM connected to the second VNFM cannot meet the information about the resource that is applied for, receive a second feedback message sent by the second VNFM.

The second feedback message is used to indicate that the resource of the target VIM connected to the second VNFM cannot meet the information about the resource that is applied for.

Specifically, the second feedback message received by the receiving unit 802 further includes resource information of a remaining resource of the target VIM connected to the second VNFM, and the resource information of the remaining resource includes a resource type of the remaining resource and a resource amount of the remaining resource.

Specifically, the sending unit 801 is further configured to send a second resource request message to the second VNFM, where the second resource request message includes resource information of a reallocation resource, and the remaining resource is used by the target VIM to reserve the reallocation resource for or allocate the reallocation resource to the VNFM.

Specifically, the information about the resource that is applied for that is sent by the sending unit 801 includes a type of the resource that is applied for and an amount of the resource that is applied for.

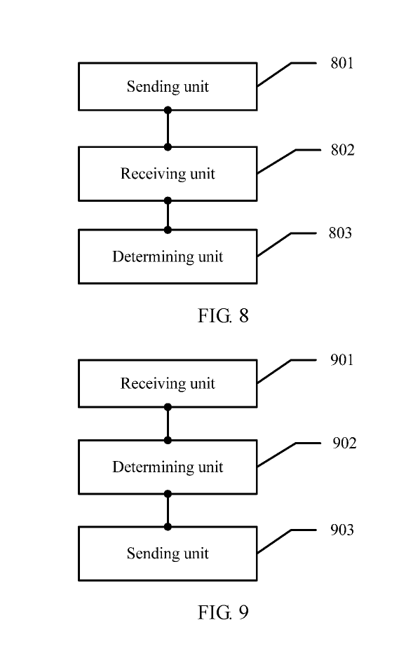

With reference to Embodiment 7 shown in FIG. 9, the following describes in detail a specific structure of a virtualized network function manager VNFM provided in this embodiment of the present invention.

The VNFM described in this embodiment is configured to implement the method performed by the second VNFM in FIG. 4 to FIG. 7A and FIG. 7B.

The VNFM includes:

a receiving unit 901, configured to receive a first resource request message sent by a first VNFM, where the first resource request message includes information about a resource for which the first VNFM applies for a virtualized network function VNF;

a determining unit 902, configured to determine that a resource of a target virtualized infrastructure manager VIM connected to the VNFM meets the information about the resource that is applied for; and

a sending unit 903, configured to: when the resource of the target virtualized infrastructure manager VIM connected to the VNFM meets the information about the resource that is applied for, send a first feedback message to the first VNFM, where the first feedback message includes information about the target VIM that has reserved a resource for or allocated a resource to the first VNFM.

The first VNFM described in this embodiment is a VNFM connected to the VNFM provided in this embodiment.

It should be noted that, in this embodiment, a specific quantity of the receiving units 901, a specific quantity of the determining units 902, and a specific quantity of the sending units 903 are not limited. That is, there may be one or more receiving units 901, there may be one or more determining units 902, and there may be one or more sending units 903.

Specifically, the sending unit 903 is further configured to send a resource reservation message to the target VIM; and

the receiving unit 901 is further configured to receive a resource reservation feedback message sent by the target VIM.

Specifically, the resource reservation message sent by the sending unit 903 includes a resource reservation identifier.

The first feedback message sent by the sending unit 903 includes the resource reservation identifier, and the resource reservation identifier is used to identify the resource reserved by the target VIM, and allocate the resource that is applied for.

Specifically, the sending unit 903 is further configured to send a second resource allocation message to the target VIM; and

the receiving unit 901 is further configured to receive a resource allocation feedback message sent by the target VIM.

Specifically, the first feedback message sent by the sending unit 903 further includes any combination of the following information: an identifier of a target virtual machine VM allocated by the target VIM, and location information of the target VM allocated by the target VIM.

Information about the target VIM that is included in the first feedback message sent by the sending unit 903 includes any combination of the following information: an identifier of the target VIM, or configuration information for establishing a connection to the target VIM.

If the resource of the VIM connected to the VNFM cannot meet the information about the resource that is applied for, the determining unit 902 is further configured to determine that the resource of the target VIM connected to the VNFM cannot meet the information about the resource that is applied for.

The sending unit 903 is configured to: when the resource of the target VIM connected to the VNFM cannot meet the information about the resource that is applied for, send a second feedback message to the first VNFM, where the second feedback message is used to indicate that the resource of the target VIM connected to the VNFM cannot meet the information about the resource that is applied for.

Specifically, the second feedback message sent by the sending unit 903 includes resource information of a remaining resource of the target VIM connected to the VNFM, and the resource information of the remaining resource includes a resource type of the remaining resource and a resource amount of the remaining resource.

Specifically, the receiving unit 901 is further configured to receive a second resource request message sent by the first VNFM, where the second resource request message includes resource information of a reallocation resource, and the remaining resource is used by the target VIM to reserve the reallocation resource for or allocate the reallocation resource to the first VNFM.

Specifically, the information about the resource that is applied for that is received by the receiving unit 901 includes a type of the resource that is applied for and an amount of the resource that is applied for.

It may be clearly understood by persons skilled in the art that, for the purpose of convenient and brief description, for a detailed working process of the foregoing system, apparatus, and unit, refer to a corresponding process in the foregoing method embodiments, and details are not described herein again.

The foregoing unit division is merely an example. Limitation is not imposed thereon.

Embodiment 8 of the present invention provides a virtualized network function manager VNFM. The virtualized network function manager VNFM in this embodiment may perform the operations of the first VNFM in the method shown in FIG. 3 and FIG. 5A and FIG. 5B to FIG. 7A and FIG. 7B.

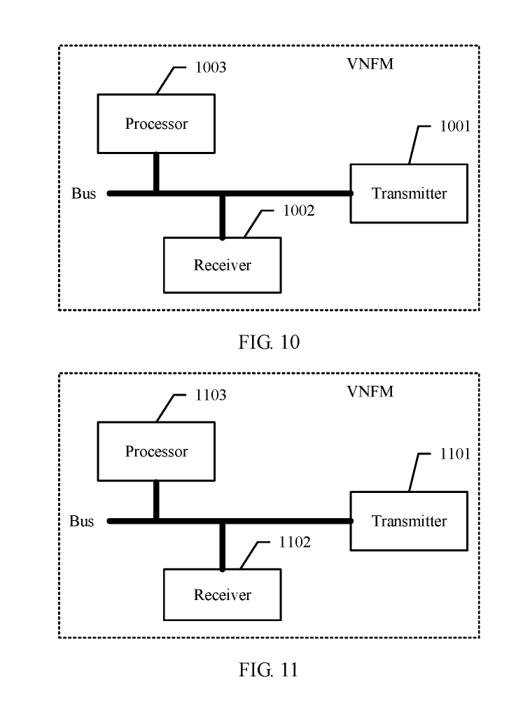

As shown in FIG. 10, the VNFM in this embodiment includes a transmitter 1001 and a receiver 1002.

The transmitter 1001 and the receiver 1002 in this embodiment are connected by using a bus. Alternatively, another connection manner may be used. A specific connection manner is not limited in this embodiment.

The related VNFM in this embodiment of the present invention may have more or fewer parts than those shown in FIG. 10, may combine two or more parts, or may have different part configurations or settings. Each part may be implemented in hardware that includes one or more signal processing and/or dedicated integrated circuits, software, or a combination of hardware and software.

The transmitter 1001 is configured to send a first resource request message to a second VNFM, where the first resource request message includes information about a resource for which the VNFM applies for a virtualized network function VNF.

The receiver 1002 is configured to: when a resource of a target virtualized infrastructure manager VIM connected to the second VNFM meets the information about the resource that is applied for, receive a first feedback message sent by the second VNFM, where the first feedback message includes information about the target VIM that has reserved a resource for or allocated a resource to the VNFM.

In this embodiment, a specific quantity of the transmitters 1001 and a specific quantity of the receivers 1002 are not limited. That is, there may be one or more transmitters 1001, and there may be one or more receivers 1002.

As shown in FIG. 10, the VNFM further includes a processor 1003.

There may be one or more processors 1003. One processor 1003 is used as an example for description in this embodiment.

The transmitter 1001, the receiver 1002, and the processor 1003 in this embodiment are connected by using a bus. Alternatively, another connection manner may be used. A specific connection manner is not limited in this embodiment.

The processor 1003 is configured to determine that the first feedback message includes the information about the target VIM that has reserved a resource for the VNFM.

The transmitter 1001 is further configured to: when the first feedback message includes the information about the target VIM that has reserved a resource for the VNFM, send a first resource allocation message to the target VIM, where the first resource allocation message is used by the target VIM to allocate the resource that is applied for.

Optionally, the first feedback message received by the receiver 1002 includes a resource reservation identifier, the first resource allocation message sent by the transmitter 1001 includes the resource reservation identifier, and the resource reservation identifier is used to identify the reserved resource.

Optionally, the processor 1003 is configured to determine that the first feedback message includes the information about the target VIM that has allocated a resource to the VNFM, where the first feedback message further includes any combination of the following information: an identifier of a target virtual machine VM allocated by the target VIM, and location information of the target VM.

Optionally, the information about the target VIM that is received by the receiver 1002 includes any combination of the following information:

an identifier of the target VIM, and configuration information for establishing a connection to the target VIM.

Optionally, the receiver 1002 is further configured to: when the resource of the target VIM connected to the second VNFM cannot meet the information about the resource that is applied for, receive a second feedback message sent by the second VNFM, where

the second feedback message is used to indicate that the resource of the target VIM connected to the second VNFM cannot meet the information about the resource that is applied for.

Optionally, the second feedback message received by the receiver 1002 further includes resource information of a remaining resource of the target VIM connected to the second VNFM, and the resource information of the remaining resource includes a resource type of the remaining resource and a resource amount of the remaining resource.

Optionally, the transmitter 1001 is further configured to send a second resource request message to the second VNFM, where the second resource request message includes resource information of a reallocation resource, and the remaining resource is used by the target VIM to reserve the reallocation resource for or allocate the reallocation resource to the VNFM.

Optionally, the information about the resource that is applied for that is sent by the transmitter 1001 includes a type of the resource that is applied for and an amount of the resource that is applied for.

Optionally, the VNFM in this embodiment may further include a memory. The memory stores a computer executable instruction used to instruct the processor 1003 to coordinate with the transmitter 1001 and the receiver 1002 to complete the operations of the first VNFM in the method shown in FIG. 3 and FIG. 5A and FIG. 5B to FIG. 7A and FIG. 7B.

Embodiment 9 of the present invention provides a virtualized network function manager VNFM. The virtualized network function manager VNFM in this embodiment may perform the operations of the second VNFM in the method shown in FIG. 4 to FIG. 7A and FIG. 7B.

As shown in FIG. 11, the VNFM in this embodiment includes a transmitter 1101, a receiver 1102, and a processor 1103.

The related VNFM in this embodiment of the present invention may have more or fewer parts than those shown in FIG. 11, may combine two or more parts, or may have different part configurations or settings. Each part may be implemented in hardware that includes one or more signal processing and/or dedicated integrated circuits, software, or a combination of hardware and software.

There may be one or more transmitters 1101, receivers 1102, and processors 1103.

The transmitter 1101, the receiver 1102, and the processor 1103 in this embodiment are connected by using a bus. Certainly, alternatively, another connection manner may be used. A specific connection manner is not limited in this embodiment.

The receiver 1102 is configured to receive a first resource request message sent by a first VNFM, where the first resource request message includes information about a resource for which the first VNFM applies for a virtualized network function VNF.

The processor 1103 is configured to determine that a resource of a target virtualized infrastructure manager VIM connected to the VNFM meets the information about the resource that is applied for.

The transmitter 1101 is configured to: when the resource of the target virtualized infrastructure manager VIM connected to the VNFM meets the information about the resource that is applied for, send a first feedback message to the first VNFM, where the first feedback message includes information about the target VIM that has reserved a resource for or allocated a resource to the first VNFM.

Optionally, the transmitter 1101 is further configured to send a resource reservation message to the target VIM; and

the receiver 1102 is further configured to receive a resource reservation feedback message sent by the target VIM.

Optionally, the resource reservation message sent by the transmitter 1101 includes a resource reservation identifier, the first feedback message sent by the transmitter 1101 includes the resource reservation identifier, and the resource reservation identifier is used to identify the resource reserved by the target VIM, and allocate the resource that is applied for.

Optionally, the transmitter 1101 is further configured to send a second resource allocation message to the target VIM.

The receiver 1102 is further configured to receive a resource allocation feedback message sent by the target VIM.

Optionally, the first feedback message sent by the transmitter 1101 further includes any combination of the following information: an identifier of a target virtual machine VM allocated by the target VIM, and location information of the target VM allocated by the target VIM.

Optionally, the information about the target VIM that is included in the first feedback message sent by the transmitter 1101 includes any combination of the following information:

an identifier of the target VIM, and configuration information for establishing a connection to the target VIM.

Optionally, the processor 1103 is further configured to determine that the resource of the target VIM connected to the VNFM cannot meet the information about the resource that is applied for.

The transmitter 1101 is further configured to: when the resource of the target VIM connected to the VNFM cannot meet the information about the resource that is applied for, send a second feedback message to the first VNFM, where the second feedback message is used to indicate that the resource of the target VIM connected to the VNFM cannot meet the information about the resource that is applied for.

Optionally, the second feedback message sent by the transmitter 1101 includes resource information of a remaining resource of the target VIM connected to the VNFM, and the resource information of the remaining resource includes a resource type of the remaining resource and a resource amount of the remaining resource.

Optionally, the receiver 1102 is further configured to receive a second resource request message sent by the first VNFM, where the second resource request message includes resource information of a reallocation resource, and the remaining resource is used by the target VIM to reserve the reallocation resource for or allocate the reallocation resource to the first VNFM.

Optionally, the information about the resource that is applied for that is received by the receiver 1102 includes a type of the resource that is applied for and an amount of the resource that is applied for.

Optionally, the VNFM in this embodiment may further include a memory. The memory stores a computer executable instruction used to instruct the processor 1103 to coordinate with the transmitter 1101 and the receiver 1102 to complete the operations of the second VNFM in the method shown in FIG. 4 to FIG. 7A and FIG. 7B.

It may be clearly understood by persons skilled in the art that, for the purpose of convenient and brief description, for a detailed working process of the foregoing system, apparatus, and unit, refer to a corresponding process in the foregoing method embodiments, and details are not described herein again.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A network functions virtualization resource processing method, comprising:
sending, by a first virtualized network function manager (VNFM), a first resource request message to a second VNFM, wherein the first resource request message comprises information about a resource for which the first VNFM applies for a virtualized network function (VNF); and
when a resource of a target virtualized infrastructure manager (VIM) connected to the second VNFM meets the information about the resource that is applied for, receiving, by the first VNFM, a first feedback message sent by the second VNFM, wherein the first feedback message comprises information about the target VIM that has reserved a resource for or allocated a resource to the first VNFM.

2. The method according to claim 1, wherein when the first feedback message comprises the information about the target VIM that has reserved a resource for the first VNFM, after the receiving, by the first VNFM, a first feedback message sent by the second VNFM, the method further comprises:
sending, by the first VNFM, a first resource allocation message to the target VIM, wherein the first resource allocation message is used by the target VIM to allocate the resource that is applied for.

3. The method according to claim 2, wherein the first feedback message comprises a resource reservation identifier, the first resource allocation message comprises the resource reservation identifier, and the resource reservation identifier is used to identify the reserved resource.

4. The method according to claim 1, wherein when the first feedback message comprises the information about the target VIM that has allocated a resource to the first VNFM, the first feedback message further comprises any combination of the following information: an identifier of a target virtual machine VM allocated by the target VIM, and location information of the target VM allocated by the target VIM.

5. The method according to claim 1, wherein the information about the target VIM comprises any combination of the following information:
an identifier of the target VIM, and configuration information for establishing a connection to the target VIM.

6. The method according to claim 1, wherein the method further comprises: when the resource of the target VIM connected to the second VNFM cannot meet the information about the resource that is applied for, receiving, by the first VNFM, a second feedback message sent by the second VNFM, wherein
the second feedback message is used to indicate that the resource of the target VIM connected to the second VNFM cannot meet the information about the resource that is applied for.

7. The method according to claim 6, wherein the second feedback message comprises resource information of a remaining resource of the target VIM connected to the second VNFM, and the resource information of the remaining resource comprises a resource type of the remaining resource and a resource amount of the remaining resource.

8. The method according to claim 7, wherein the method further comprises:
sending, by the first VNFM, a second resource request message to the second VNFM, wherein the second resource request message comprises resource information of a reallocation resource, and the remaining resource is used by the target VIM to reserve the reallocation resource for or allocate the reallocation resource to the first VNFM.

9. The method according to claim 1, wherein the information about the resource that is applied for comprises a type of the resource that is applied for and an amount of the resource that is applied for.

10. A virtualized network function manager (VNFM), comprising:
a transmitter, configured to send a first resource request message to a second VNFM, wherein the first resource request message comprises information about a resource for which the VNFM applies for a virtualized network function (VNF); and
a receiver, configured to: when a resource of a target virtualized infrastructure manager (VIM) connected to the second VNFM meets the information about the resource that is applied for, receive a first feedback message sent by the second VNFM, wherein the first feedback message comprises information about the target VIM that has reserved a resource for or allocated a resource to the VNFM.

11. The VNFM according to claim 10, wherein the VNFM further comprises a processor, wherein
the processor is configured to determine that the first feedback message comprises the information about the target VIM that has reserved a resource for the VNFM; and
the transmitter is further configured to: when the first feedback message comprises the information about the target VIM that has reserved a resource for the VNFM, send a first resource allocation message to the target VIM, wherein the first resource allocation message is used by the target VIM to allocate the resource that is applied for.

12. The VNFM according to claim 11, wherein
the first feedback message received by the receiver comprises a resource reservation identifier, the first resource allocation message sent by the transmitter comprises the resource reservation identifier, and the resource reservation identifier is used to identify the reserved resource.

13. The VNFM according to claim 10, wherein the VNFM further comprises a processor, wherein
the processor is configured to determine that the first feedback message comprises the information about the target VIM that has allocated a resource to the VNFM, wherein the first feedback message further comprises any combination of the following information: an identifier of a target virtual machine VM allocated by the target VIM, and location information of the target VM.

14. The VNFM according to claim 10, wherein the information about the target VIM that is received by the receiver comprises any combination of the following information:
an identifier of the target VIM, and configuration information for establishing a connection to the target VIM.

15. The VNFM according to claim 10, wherein
the receiver is further configured to: when the resource of the target VIM connected to the second VNFM cannot meet the information about the resource that is applied for, receive a second feedback message sent by the second VNFM, wherein
the second feedback message is used to indicate that the resource of the target VIM connected to the second VNFM cannot meet the information about the resource that is applied for.

16. The VNFM according to claim 15, wherein the second feedback message received by the receiver further comprises resource information of a remaining resource of the target VIM connected to the second VNFM, and the resource information of the remaining resource comprises a resource type of the remaining resource and a resource amount of the remaining resource.

17. The VNFM according to claim 16, wherein
the transmitter is further configured to send a second resource request message to the second VNFM, wherein the second resource request message comprises resource information of a reallocation resource, and the remaining resource is used by the target VIM to reserve the reallocation resource for or allocate the reallocation resource to the VNFM.

18. The VNFM according to claim 10, wherein the information about the resource that is applied for that is sent by the transmitter comprises a type of the resource that is applied for and an amount of the resource that is applied for.

19. A non-transitory computer readable storage medium storing a program to be executed by at least one processor, the program comprising instructions for:
sending a first resource request message to a second VNFM, wherein the first resource request message comprises information about a resource for which a first VNFM applies for a virtualized network function (VNF); and
when a resource of a target virtualized infrastructure manager (VIM) connected to the second VNFM meets the information about the resource that is applied for, receiving a first feedback message sent by the second VNFM, wherein the first feedback message comprises information about the target VIM that has reserved a resource for or allocated a resource to the first VNFM.

20. The non-transitory computer readable storage medium according to claim 19, wherein when the first feedback message comprises the information about the target VIM that has reserved a resource for the first VNFM, the program further comprises instructions for,
sending a first resource allocation message to the target VIM, wherein the first resource allocation message is used by the target VIM to allocate the resource that is applied for.
